(19) United States
(12) Patent Application Publication
(10) Pub. No.: US 2025/0205779 A1
(43) Pub. Date: Jun. 26, 2025

(54) MULTI-STACK SPARK PLASMA SINTERING PARALLEL MANUFACTURING

(71) Applicant: ATS IP, LLC, Fort Collins, CO (US)

(72) Inventors: Jake PEREZ, Fort Collins, CO (US); Ion BASA, Fort Collins, CO (US); Kelly ADAMS, Edmonton (CA)

(21) Appl. No.: 18/850,663

(22) PCT Filed: Mar. 30, 2023
(86) PCT No.: PCT/US23/16842

§ 371 Date: Sep. 25, 2024

Related U.S. Application Data
(60) Provisional application No. 63/326,727, filed on Apr. 1, 2022.

(51) Int. Cl. B22F 3/105; B22F 3/00

(52) U.S. Cl. CPC B22F 3/105; B22F 3/003; B22F 2003/1051

(57) ABSTRACT

Systems and methods herein provide for an increased throughput and consistency of the spark plasma sintering (SPS) process. One SPS system includes an electrical energy source, and a first SPS module that includes a first die operable to shape a first wafer, and first and second punches operable to compress the first wafer into the first die using electrical energy from the electrical energy source. A second SPS module is stacked atop the first SPS module. and includes a second die operable to shape a second wafer; and third and fourth punches operable to compress the second wafer into the second die using electrical energy from the electrical energy source. The system also includes a controller operable to independently provide the electrical energy from the electrical energy source to each of the first and second SPS modules to provide a substantially even thermal distribution through the first and second wafers.

### CROSS REFERENCE TO RELATED APPLICATIONS

This patent application claims priority to, and thus the benefit of an earlier filing date from, U.S. Provisional Patent Application No. 63/326,727 (filed Apr. 1, 2022), the contents of which are hereby incorporated by reference.

### BACKGROUND

Spark Plasma Sintering (SPS) machines are devices that convert powder to a sintered wafer (e.g. a semiconductor wafer). An SPS machine operates by utilizing a hydraulic ram or an electric ram to compress the powder, which is housed in a die. The SPS machine then applies large amounts of electrical current to the powder to induce heat in the powder and to form an electric field in the powder such that the powder crystallizes. For example, SPS machines may apply electrical current from a power supply to two hydraulic rams, a lower ram and an upper ram. Each ram is bonded to the power supply. When a single die is mounted between the hydraulic rams, the electrical circuit is completed, and power is applied. Heating occurs in the die as a result.

SPS machines are designed to accept a single die to produce a single part (e.g., a single semiconductor wafer). Throughput is determined by the sintering “recipe” and the number of SPS machines at a facility. Multi-die manufacturing, also known as multi-stack manufacturing, can increase throughput on a single SPS machine. In multi-stack manufacturing, a number of dies are stacked on top of each other in an SPS machine chamber. However, an inconsistent temperature distribution across the dies is an inherent problem with multi-stack setups that increases as more dies are introduced. The inconsistent temperature distribution is marginally acceptable for certain materials which are resistant to heat variations. However, uneven heat distribution with current generation SPS machines poses a problem for multi-stack operations using materials that are susceptible to heat variation, as such can impact performance of the materials.

### SUMMARY

Systems and methods herein provide for multi-stack SPS manufacturing methods. These systems and methods provide for increased consistency and better performance of resulting crystalline products by making the thermal distribution in each multi-stack die emulate a single die SPS run. This allows the system to utilize the force exerted by the hydraulic rams on all dies simultaneously while maintaining the desired temperature distributions.

In one embodiment, an SPS system includes an electrical energy source, and a first SPS module that includes a first die operable to shape a first wafer, and first and second punches operable to compress the first wafer into the first die using electrical energy from the electrical energy source. The system also includes a second SPS module stacked atop the first SPS module. The second SPS module includes a second die operable to shape a second wafer; and third and fourth punches operable to compress the second wafer into the second die using electrical energy from the electrical energy source. The system also includes a controller operable to independently provide the electrical energy from the electrical energy source to each of the first and second SPS modules to provide a substantially even thermal distribution through the first and second wafers.

In some embodiments, the controller is further operable to process temperature feedback from each die, and to modify a heating profile of each die based on the temperature feedback to prevent thermal runaway of the dies. An insulator may be configured between the first and second SPS modules, and operable to control the thermal distribution between the first and second dies, and to decouple the electrical energy current through the first and second SPS modules. In some embodiments, the controller is operable to independently modulate the electrical energy from the electrical energy source to the first and third punches. In some embodiments, the SPS system includes at least one more SPS module having another die operable to shape another wafer, and fifth and sixth punches operable to compress the other wafer into the other die using electrical energy from the electrical energy source. In some embodiments, the controller is further operable to detect a temperature of each of the dies, and to independently adjust the electrical energy to each of the first and second SPS modules based on the detected temperatures of each of the dies.

In some embodiments, the system is configured with insulating spacers, electrical contact plates, and power lines to connect the dies. In another embodiment, the system includes one or more controllers, power supplies, and proportional integral derivative (PID) control loops. Each PID control loop and controller may be connected to each independent die in an SPS chamber. Each independent die may be separated by an electric and thermal insulator, and may have independent thermocouples and/or temperature sensors.

In some embodiments, a double stack of two separate dies is independently heated in a single spark plasma sintering cycle. This independent heating allows higher control of each independent die as well as a doubled throughput of the spark plasma sintering machine. This increase in parts produced, coupled with independent heating, allows for a more consistent and controllable part regarding performance and crystallization, while still maintaining a high production rate. The system may employ one or more controllers to control independent/parallel current paths to heat each wafer independently, but in a substantially identical manner.

The various embodiments disclosed herein may be implemented in a variety of configurations as a matter of design choice. For example, some embodiments herein are implemented in hardware whereas other embodiments may include processes that are operable to implement and/or operate the hardware. Other exemplary embodiments, including software and firmware.

### BRIEF DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of an exemplary stacked SPS system.

FIG. 2 is a block diagram of the stacked SPS system of FIG. 1 with independently controlled heating.

FIG. 3 is a flowchart of an exemplary process of an SPS system.

FIG. 4 is a block diagram of an exemplary control loop architecture of an SPS system.

FIG. 5 is a block diagram of an exemplary control loop architecture of another SPS system.

FIG. 6 is a block diagram of an exemplary multi-SPS system control loop architecture.

FIG. 7 is a block diagram of an exemplary computing system in which a computer readable medium provides instructions for performing methods herein.

### DETAILED DESCRIPTION

The figures and the following description illustrate specific exemplary embodiments. It will thus be appreciated that those skilled in the art will be able to devise various arrangements that, although not explicitly described or shown herein, embody certain principles and are included within the scope of the embodiments. Furthermore, any examples described herein are intended to aid in understanding the embodiments and are to be construed as being without limitation to such specifically recited examples and conditions. As a result, the embodiments are not limited to any of the examples described below.

In some embodiments, a system uses parallel current, instead of series, to heat each die independently while in the SPS machine. For example, a single-source technique may include using a single power supply with parallel wiring connections. A single source is easier to implement because it requires less equipment and can be used with current generation SPS machines. But such techniques have the possibility of thermal runaway. Alternatively, a multisource technique may include using multiple power supplies to power each individual die. The multisource approach is more complex since there are “n” number of power supplies to match “n” number of dies. The multisource approach, however, does not have thermal runaway issues because it does not rely on a single die control loop methodology that is applied to multiple dies.

Using parallel electrical heating makes each die experience common heat distributions in the SPS chamber. This is because the resistance seen by the current path is the same as if it were a single die setup. This can be implemented by adding an electrical and temperature insulator in between each of the dies in the chamber and wiring a power and ground to each individual die. The insulative material should be able to withstand the current output needed to cause heating and the force output of the hydraulic rams. Candidate materials for this application include ceramics such as zirconia or wollastonite. Since an SPS machine operates by using current to generate heat at the resistive barriers, each section acts as an independent resistor, this decouples the dies when heating.

Now that each die is decoupled, heating may be controlled using a single controller that handles the current sent in parallel to “n” number of dies. This is an elegant technique but has the possibility of thermal runaway. Alternatively, independent controllers may be used for each die, this method is more complex but substantially reduces the possibility of thermal runaway. This is due to each controller maintaining the heating of the independent dies so that they receive the correct amount of current.

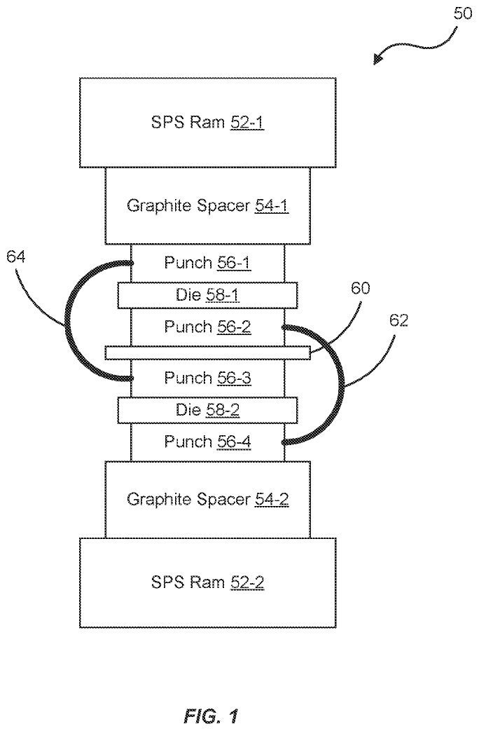

With this in mind, FIG. 1 is a block diagram of an exemplary stacked SPS system 50. In this embodiment, the SPS system 50 comprises top and bottom SPS rams 52-1 and 52-2 that are used to compress the semiconductor material in the dies 58-1 and 58-2. Graphite spacers 54-1 and 54-2 between the SPS rams 52 and the punches 56 (i.e., graphite spacer 54-1 between SPS ram 52-1 and punch 56-1, and graphite spacer 54-2 between SPS ram 52-2 and punch 56-4) provide insulation to the SPS system 50 such that thermal energy is focused in the dies 58-1 and 58-2. Another layer of insulation 60 is placed between the punches 56-2 and 56-3 to ensure that the thermal energy applied to the dies 58-1 and 58-2 is consistent.

The punches 56 apply the thermal energy to the dies 58 by the controlled electrical energy to the punches 56. For example, punches 56-1 and 56-3 are electrically coupled to one another via powerline 64 so as to receive electrical energy and convert that electrical energy into thermal energy via resistive heating. The punches 56-2 and 56-4 are electrically grounded to one another via powerline 62. In this regard, the heating of the dies 58-1 and 58-2 singularly controlled.

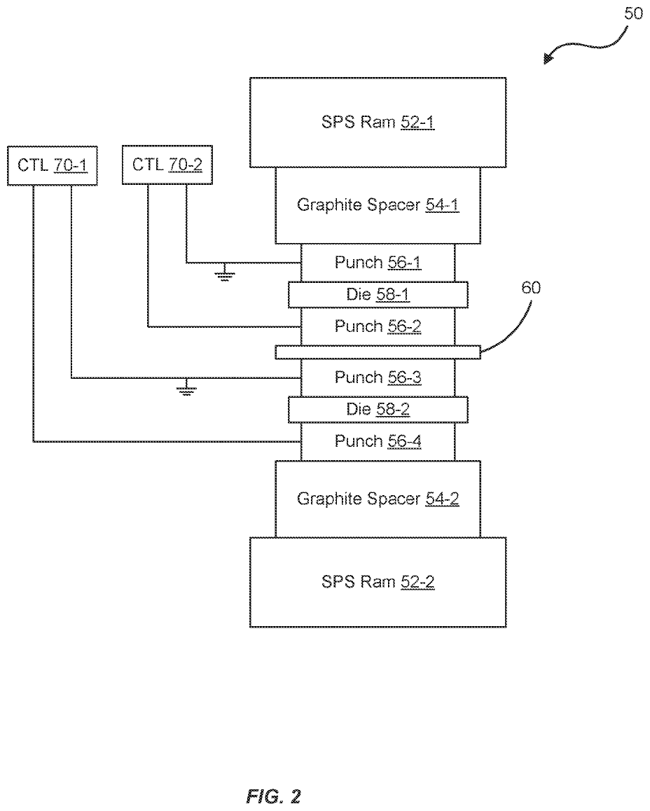

FIG. 2 is a block diagram of the stacked SPS system 50 with independently controlled heating. In this embodiment, the SPS system 50 employs two controllers 70-1 and 70-2. The controller 70-1 supplies electrical energy to the punch 56-3 and ground to the punch 56-4, whereas the controller 70-2 applies electrical energy to the punch 56-2 and ground to the punch 56-1. This independent application of electrical energy to the punches 56 allows for a consistent heating of the dies 58-1 and 58-2. In some embodiments, the system 50 may employ a feedback loop where the temperatures of the dies 58 are fed to the controllers 70-1 and 70-2 to ensure that the heating of the dies 58 remains consistent. In some embodiments, this feedback loop is a PID feedback loop.

The PID feedback loop implemented by the SPS system 50 may track parameters. such as temperature, electrical current, and temperature ramp rate (i.e., rate of change). For temperature measurements, thermocouples or other temperature sensing elements may be embedded in the SPS system 50, typically in the die 58 and punch 56 locations. Such devices may track the temperature of the die 58, powder material to be sintered, and punches 56. The current from the power supply, which induces heating, may controlled cither by the PID loop.

When controlled by the PID feedback loop, current is measured as the input and the output is a corelated temperature. The rate at which this output change occurs is controlled by the P, I, and D parameters, which stand for proportional, integral, derivative, respectively. The ramp rate is controlled by the PID parameters and, with the controller 70, controls the amount of current going through the internal SPS chamber. The amount of current directly correlates to induced heat on the die 58 and the semiconductor powder therein. The accuracy and control of the PID loop may be controlled by the amount of temperature sensing elements and their locations, the accuracy of the direct current (DC) power supplies and current control, and the training of the PID parameters in the controller 70. The PID parameters may depend on the size of die 58, the shape of the die 58, the amount of semiconductor powder in the die, the kind of powder, and the like.

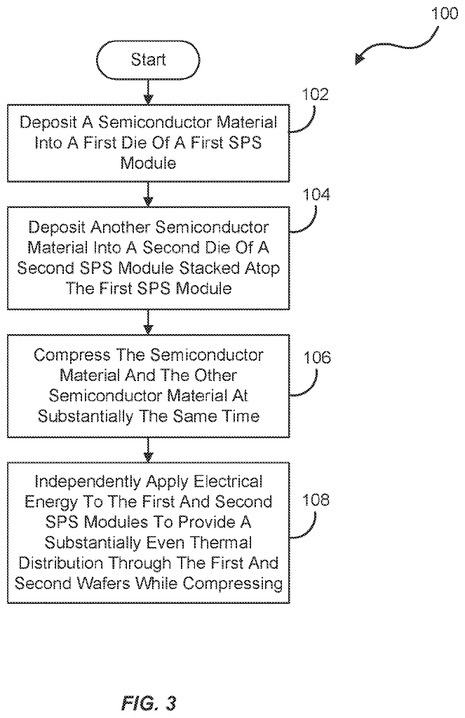

FIG. 3 is a flowchart of an exemplary process of the SPS system 50. In this embodiment, semiconductor material is deposited in a first die 58-2 of a first SPS module (e.g., configured from the elements SPS ram 52-2, graphite spacer 54-2, punch 56-3, and punch 56-4), in the process element 102. And in a second die 58-1 of a second SPS module stacked atop the first SPS module (e.g., configured from the elements SPS ram 52-1, graphite spacer 54-1, punch 56-1, and punch 56-2) another semiconductor material is deposited, in the process element 104. The other semiconductor material deposited in the die 58-2 can be the same or different than the semiconductor material deposited in the die 58-1. However, different materials may result in different heating requirements of the dies 58-1 and 58-2. This can be managed via independently controlled heating of the dies 58-1 and 58-2.

With the semiconductor materials in their respective dies 58-1 and 58-2, the SPS system 50 begins compressing the semiconductor materials at substantially the same time, in the process element 106. For example, the SPS rams 52 may begin compressing the stack of punches 56, dies 58, and graphite spacers 54. And, while this is happening, the controller 70 may independently apply electrical energy to the first and second SPS modules to provide a substantially even thermal distribution through the first and second wafers being produced from the semiconductor materials in the dies 58, in the process element 108.

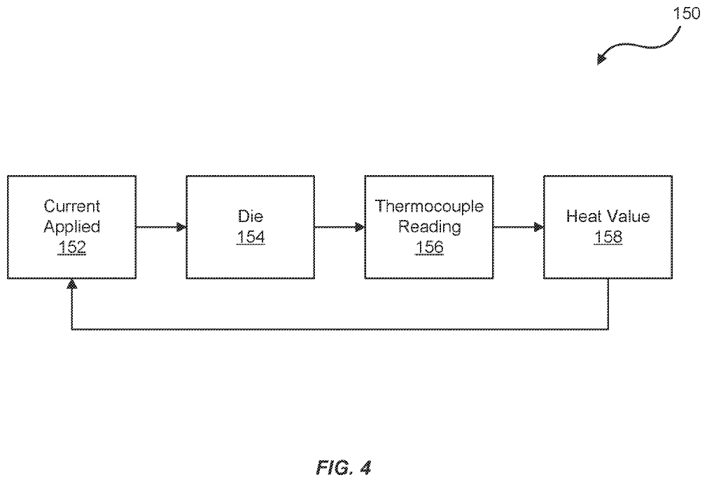

FIG. 4 is a block diagram of an exemplary control loop architecture of an SPS system 150. In this embodiment, a single die 154 is used as a test point for the temperature reading via the thermocouple or other temperature sensor reading 156. This single temperature measurement (i.e., heat value 158) may be used to control the electrical current 152 applied to the SPS system. For example, the control loop architecture may implement a PID feedback loop that uses the heat value 158 as the feedback to control the current applied 152 to the system 150.

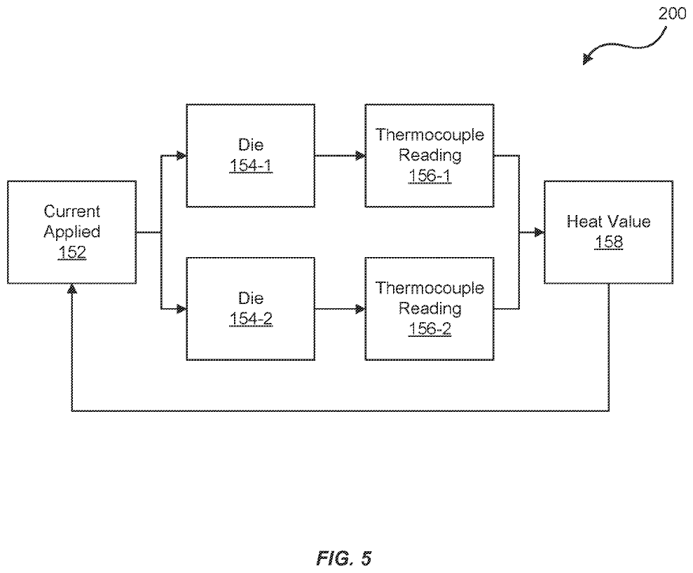

FIG. 5 is a block diagram of an exemplary control loop architecture of a multi-SPS system control loop architecture 200. In this embodiment, the SPS system 200 comprises a stacked SPS module configuration such as that in FIG. 2. The current applied 152 from a SPS machine power supply is distributed to both dies 154-1 and 154-2 evenly via parallel electrical wiring of the dies 154-1 and 154-2. The highest thermocouple reading of 156-1 and 156-2 produces the heat value 158 that can be used to control the current applied 152. Alternatively, the average of multiple thermocouple readings 156 can be used as feedback in the control loop.

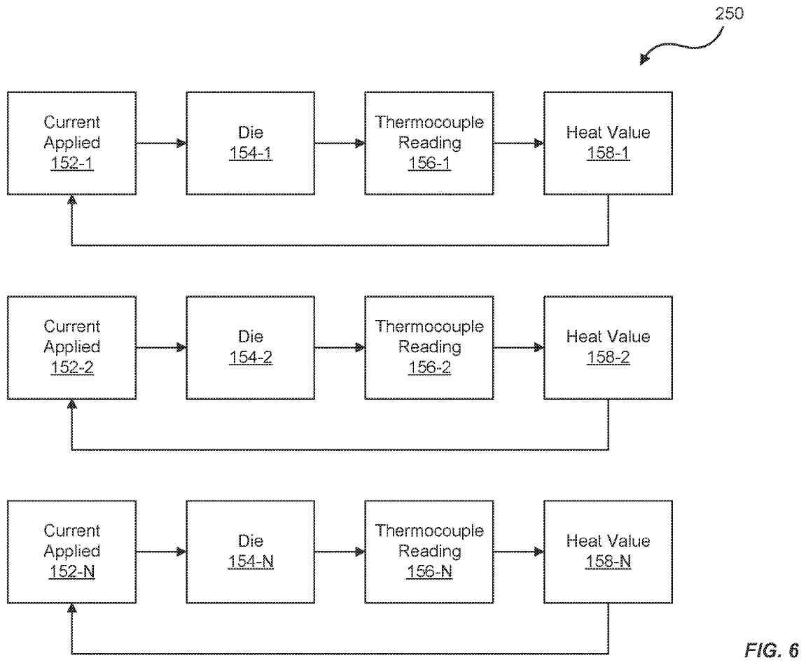

FIG. 6 is a block diagram of another exemplary multi-SPS system control loop architecture. In this embodiment, the dies 154-1-154-N (where the reference “N” is an integer greater than “1” and not necessarily equal to any other “N” reference designated herein) may be configured in a stacked configuration such as the SPS system 50 of FIG. 2. In this embodiment, each SPS module in the stack has an independent feedback loop that uses its thermocouple reading 156 of its respective die 154 to produce the heat value 158 that is fed back to the current applied 152 to the die 154.

The embodiments herein provide for many advantages over the present state of the art. For example, the SPS embodiments herein may increase throughput without degrading part quality. A single source technique of parallel die heating can be implemented to existing and future SPS machines without modifications to the SPS machine or power supply. The single source technique can also overcome temperature distribution variations present in previous SPS machine dies. A multisource technique of parallel die heating can overcome thermal runaway. In some embodiments, the multisource technique uses a control loop architecture where each die is individually controlled for temperature by modulating the output power independently from all dies in an SPS die stack. The embodiments disclosed herein can be used in semiconductor wafer manufacturing to overcome problems found on previous SPS machines.

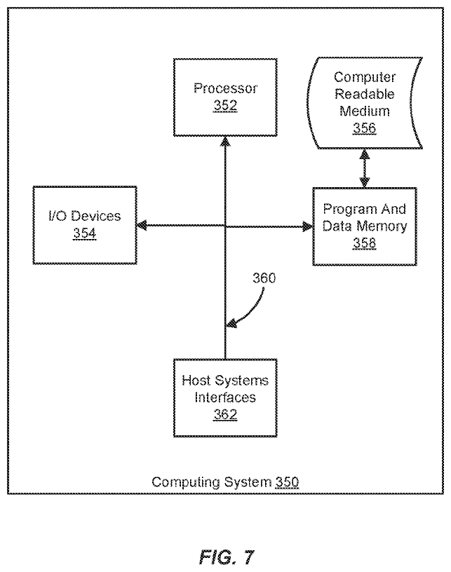

Any of the above embodiments herein may be rearranged and/or combined with other embodiments. Accordingly, the concepts herein are not to be limited to any embodiment disclosed herein. Additionally, the embodiments can take the form of entirely hardware or comprising both hardware and software elements. Portions of the embodiments may be implemented in software, which includes but is not limited to firmware, resident software, microcode, etc. FIG. 7 illustrates a computing system 350 in which a computer readable medium 356 may provide instructions for performing any of the methods disclosed herein.

Furthermore, the embodiments can take the form of a computer program product accessible from the computer readable medium 356 providing program code for use by or in connection with a computer or any instruction execution system. For the purposes of this description, the computer readable medium 356 can be any apparatus that can tangibly store the program for use by or in connection with the instruction execution system, apparatus, or device, including the computer system 350.

The medium 356 can be any tangible electronic, magnetic, optical, electromagnetic, infrared, or semiconductor system (or apparatus or device). Examples of a computer readable medium 356 include a semiconductor or solid state memory, magnetic tape, a removable computer diskette, a random access memory (RAM), NAND flash memory, a read-only memory (ROM), a rigid magnetic disk and an optical disk. Some examples of optical disks include compact disk-read only memory (CD-ROM), compact disk-read/write (CD-R/W) and digital versatile disc (DVD).

The computing system 350, suitable for storing and/or executing program code, can include one or more processors 352 coupled directly or indirectly to memory 358 through a system bus 360. The memory 358 can include local memory employed during actual execution of the program code, bulk storage, and cache memories which provide temporary storage of at least some program code in order to reduce the number of times code is retrieved from bulk storage during execution. Input/output or I/O devices 354 (including but not limited to keyboards, displays, pointing devices, etc.) can be coupled to the system either directly or through intervening I/O controllers. Network adapters may also be coupled to the system to enable the computing system 350 to become coupled to other data processing systems, such as through host systems interfaces 362, or remote printers or storage devices through intervening private or public networks. Modems, cable modem and Ethernet cards are just a few of the currently available types of network adapters.

What is claimed is:

1. A Spark Plasma Sintering (SPS) system, comprising:
an electrical energy source;
a first SPS module comprising:
a first die operable to shape a first wafer; and
first and second punches operable to compress the first wafer into the first die using electrical energy from the electrical energy source;
a second SPS module stacked atop the first SPS module and comprising:
a second die operable to shape a second wafer; and
third and fourth punches operable to compress the second wafer into the second die using electrical energy from the electrical energy source; and
a controller operable to independently provide the electrical energy from the electrical energy source to each of the first and second SPS modules to provide a substantially even thermal distribution through the first and second wafers.

2. The SPS system of claim 1, wherein:
the controller is further operable to process temperature feedback from each die, and to modify a heating profile of each die based on the temperature feedback to prevent thermal runaway of the dies.

3. The SPS system of claim 1, further comprising:
an insulator configured between the first and second SPS modules, and operable to control the thermal distribution between the first and second dies, and to decouple the electrical energy current through the first and second SPS modules.

4. The SPS system of claim 1, wherein:
the controller is operable to independently modulate the electrical energy from the electrical energy source to the first and third punches.

5. The SPS system of claim 1, further comprising:
at least one more SPS module, comprising:
another die operable to shape another wafer; and
fifth and sixth punches operable to compress the other wafer into the other die using electrical energy from the electrical energy source.

6. The SPS system of claim 1, wherein:
the controller is further operable to detect a temperature of each of the dies, and to independently adjust the electrical energy to each of the first and second SPS modules based on the detected temperatures of each of the dies.

7. A method, comprising:
depositing a semiconductor material into a first die, the first die being configured in a first Spark Plasma Sintering (SPS) module that includes first and second punches operable to compress the semiconductor material in the first die into a first semiconductor wafer;
depositing another semiconductor material into a second die, the second die being configured in a second SPS module stacked atop the first SPS module, the second SPS module including third and fourth punches operable to compress the other semiconductor material in the second die into a second semiconductor wafer;
compressing the semiconductor material and the other semiconductor material at substantially the same time; and
independently applying electrical energy to the first and second SPS modules to provide a substantially even thermal distribution through the first and second wafers while compressing the semiconductor material and the other semiconductor material.

8. The method of claim 7, further comprising:
processing temperature feedback from each die; and
modifying a heating profile of each die based on the temperature feedback to prevent thermal runaway of the dies.

9. The method of claim 7, further comprising:
controlling the thermal distribution and an electrical distribution between the first and second dies with an insulator configured between the first and second SPS modules.

10. The method of claim 7, further comprising:
independently modulating the electrical energy from the electrical energy source to the first and third punches.

11. The method of claim 7, further comprising:
shaping another wafer in another die of another SPS module stacked atop the second SPS module by compressing the other wafer into the other die.

12. The method of claim 7, further comprising:
detecting a temperature of each of the dies; and
independently adjusting the electrical energy to each of the first and second SPS modules based on the detected temperatures of each of the dies.

13. A non-transitory computer readable medium operable with a processor in a Spark Plasma Sintering (SPS) system comprising a first SPS module that comprises a first die and first and second punches, said first die having a semiconductor material deposited therein, the SPS system further comprising a second SPS module that comprises a second die and third and fourth punches, said second die having a semiconductor material deposited therein, the computer readable medium comprising instructions that, when executed by the processor, direct the processor to:
compress the semiconductor material and the other semiconductor material at substantially the same time; and
independently apply electrical energy to the first and second SPS modules to provide a substantially even thermal distribution through the first and second wafers while compressing the semiconductor material and the other semiconductor material.

14. The computer readable medium of claim 13, further comprising that direct the processor to:
process temperature feedback from each die; and
modify a heating profile of each die based on the temperature feedback to prevent thermal runaway of the dies.

15. The computer readable medium of claim 13, further comprising that direct the processor to:
control the thermal distribution and an electrical distribution between the first and second dies with an insulator configured between the first and second SPS modules.

16. The computer readable medium of claim 13, further comprising that direct the processor to:
independently modulate the electrical energy from the electrical energy source to the first and third punches.

17. The computer readable medium of claim 13, further comprising that direct the processor to:
shape another wafer in another die of another SPS module stacked atop the second SPS module by compressing the other wafer into the other die.

18. The computer readable medium of claim 13, further comprising that direct the processor to:
detect a temperature of each of the dies; and
independently adjust the electrical energy to each of the first and second SPS modules based on the detected temperatures of each of the dies.
